(19) United States
(12) Patent Application Publication
(10) Pub. No.: US 2008/0122583 A1
(43) Pub. Date: May 29, 2008

(54) System and method for RFID tag communication

(76) Inventor: Benjamin Bekritsky, Hollis, NY (US)

Correspondence Address: FAY KAPLUN & MARCIN, LLP, 150 BROADWAY, SUITE 702, NEW YORK, NY, 10038, US

(21) Appl. No.: 11/604,627

(22) Filed: Nov. 27, 2006

(51) Int. Cl. H04Q 5/22

(52) U.S. Cl. 340/10.32

(57) ABSTRACT

Described is system and method for RFID tag communication including transmitting a command signal in a time slot to a plurality of wireless communication devices, the command signal indicating initiation of an identification process for identifying each of the wireless devices, the identification process including a plurality of time slots and computing a probability that a subsequent command signal transmitted in a subsequent time slot will cause only one of the wireless devices to transmit a response signal in the subsequent time slot.

### FIELD OF THE INVENTION

The present invention relates generally to systems and methods for identifying and communicating with radio frequency identification (RFID) tags/labels.

### BACKGROUND

The EPC® Radio Frequency Identity Protocols, Class-1 Generation-2 UHF RFID, Protocol for Communications at 860 MHz-960 MHz, Version 1.0.8 (“the Gen2 specification”) defines physical and logical requirements for a passive-backscatter, interrogator-talks-first (ITF), radio frequency identification (RFID) system. In the RFID system, RFID interrogators manage RFID tag populations using three basic processes: Select, Inventory and Access. During the Select process, the interrogator selects a population of tags. In the Inventory process, the interrogator identifies the tags in the population, and the interrogator interfaces with (reads from/writes to) the tags in the Access process.

During the Inventory process, the interrogator utilizes a slot-count (Q) selection algorithm to identify all of the tags in the population. While the Gen2 specification provides an exemplary Q selection algorithm, optimizations may be utilized to decrease the time required for identifying all of the tags in the population.

### SUMMARY OF THE INVENTION

The present invention relates to a method for transmitting a command signal in a time slot to a plurality of wireless communication devices, the command signal indicating initiation of an identification process for identifying each of the wireless devices, the identification process including a plurality of time slots and computing a probability that a subsequent command signal transmitted in a subsequent time slot will cause only one of the wireless devices to transmit a response signal in the subsequent time slot.

The present invention also relates to a device having a wireless communication arrangement transmitting a command signal in a time slot to a plurality of wireless communication devices, the command signal indicating initiation of an identification process for identifying each of the wireless devices, the identification process including a plurality of time slots and a processor computing a probability that a subsequent command signal transmitted in a subsequent time slot will cause only one of the wireless devices to transmit a response signal in the subsequent time slot.

The present invention further relates to a system having a plurality of first wireless communication devices and a second wireless communication device transmitting a command signal in a time slot to the first devices, the command signal indicating initiation of an identification process for identifying each of the first devices, the identification process including a plurality of time slots, the second device computing a probability that a subsequent command signal transmitted in a subsequent time slot will cause only one of the first devices to transmit a response signal in the subsequent time slot.

### DESCRIPTION OF THE DRAWINGS

FIG. 1 shows an exemplary embodiment of a system according to present invention.

FIG. 2 shows an exemplary embodiment of a method according to the present invention.

FIG. 3a shows an exemplary timing diagram of an empty slot according to the present invention.

FIG. 3b shows an exemplary timing diagram of a single-tag slot according to the present invention.

FIG. 3c shows an exemplary timing diagram of a collided slot according to the present invention.

### DETAILED DESCRIPTION

The present invention may be further understood with reference to the following description and the appended drawings, wherein like elements are referred to with the same reference numerals. The present invention describes a system and method for RFID tag communication. While the exemplary embodiments of the present invention will be described with reference to RFID devices that operate in accordance with the Gen2 specification, those of skill in the art will understand that the systems and methods may be utilized in any RFID system and may be utilized in other wireless communication systems that utilize other protocols, standards, specifications, etc.

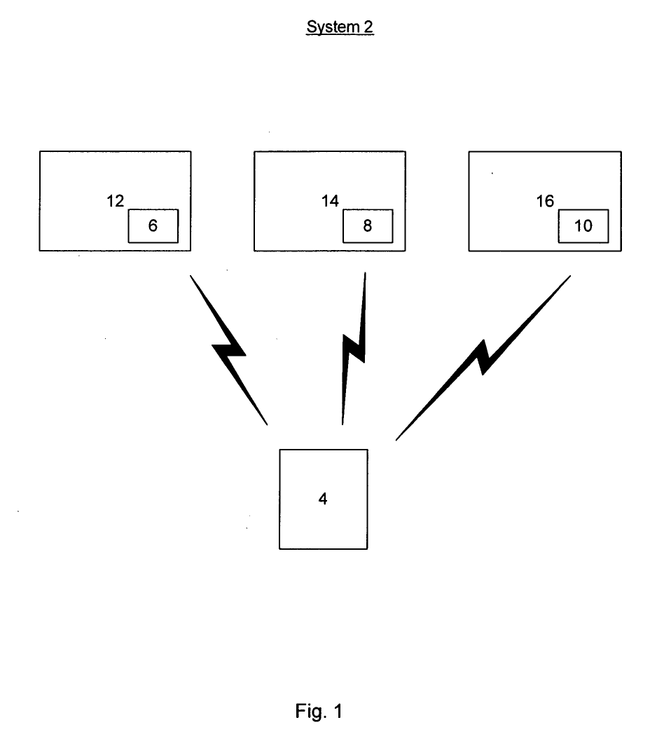

FIG. 1 shows an exemplary embodiment of a system 2 for RFID tag communication according to the present invention. The system 2 includes a first wireless computing device which utilizes a communication arrangement (e.g., an RFID interrogator/reader 4) to identify and interface with at least one second wireless computing device (e.g., RFID tags 6-10), in a wireless reading range of the interrogator 4. As is known by those of skill in the art, the tags 6-10 may be coupled to items 12-16, respectively, and store data for identifying the items 12-16. The items 12-16 may be, for example, consumer/food products, product packaging, shipping containers, animals, etc. By reading the data stored on the tags 6-10, the interrogator 4 may be utilized in a tracking/inventorying process to identify locations of (or other data related to) the items 12-16. The data on the tags 6-10 may include passwords for interfacing with the tags 6-10, product identifiers (e.g., an electronic product code, a product code (e.g., a UPC/EAN), proprietary codes), feature data identifying supported commands, capabilities, etc., and reserved space for user-specific/proprietary data that may be pre-programmed and/or written to the tags 6-10 during use.

An Inventory process/round is used to identify the tags 6-10 in the tag population. The Inventory process begins when the interrogator 4 transmits a Query command signal which includes inventory round data such as, for example, data identifying the tags 6-10 that should participate in the inventory round, a data rate for communication between the interrogator 4 and the tags 6-10 during the inventory round and a parameter Q for setting a number of slots N in the first frame of the inventory round. Initially, per the Gen2 specification, each tag includes a number of flags set to a particular value. For example, there may be four (4) inventory flags, each of which is associated with a session (e.g., S0, S1, S2, S3). Each of the inventory flags has one of two states (e.g., A or B). When starting an inventory round, the interrogator 4 may indicate which tags should participate in the inventory round by indicating a session and a state value (e.g., S1 and A). Thus, each of the tags that has a session 1 flag value of A will participate in the inventory round. Those skilled in the art will understand that the above is only exemplary and that other methods may be used to determine the tags that will participate in the inventory round.

As per the Gen2 specification, the parameter Q is limited to a value between 0 and 15, and the number of slots N in the inventory round is set to 2^{Q}. Thus, the number of slots N in the inventory round may range from 1 to 32768. Each Query command starts a new frame and the number of slots in the frame is equal to the determined number of slots, i.e., 2^{Q}. Upon receiving the Query command signal, each of the tags 6-10 determines the number of slots N in the inventory round by N=2^{Q} and generates and loads a random number, from 0 to N−1, into a slot counter thereof. As will be described further below, the random number is used to determine a slot in which the tag will respond to the interrogator 4.

As the inventory round progresses, the interrogator 4 may transmit QueryRepeat and/or QueryAdjust command signals. Upon receipt of the QueryRepeat command signal, each of the tags 6-10 decrements a value in its respective slot counter by 1. As will be described below in greater detail, each QueryRepeat command will start a new time slot in the current frame.

The QueryAdjust command ends the previous frame (e.g., started by the initial Query command or a previous QueryAdjust command) and begins a new frame having 2^{Q} time slots, where Q is the new Q that is set by the QueryAdjust command. The QueryAdjust command signal allows the interrogator 4 to increment, decrement or maintain the parameter Q from the previous frame. Upon receipt of the QueryAdjust command signal, each of the tags 6-10 recalculates the number of slots N in the inventory round, and generates and loads a new random number into its slot counter. As understood by those skilled in the art, the QueryAdjust command may be considered to re-randomize the tags 6-10. Throughout the remainder of this description, the Query, QueryRepeat and QueryAdjust commands will be referred to collectively as command signals.

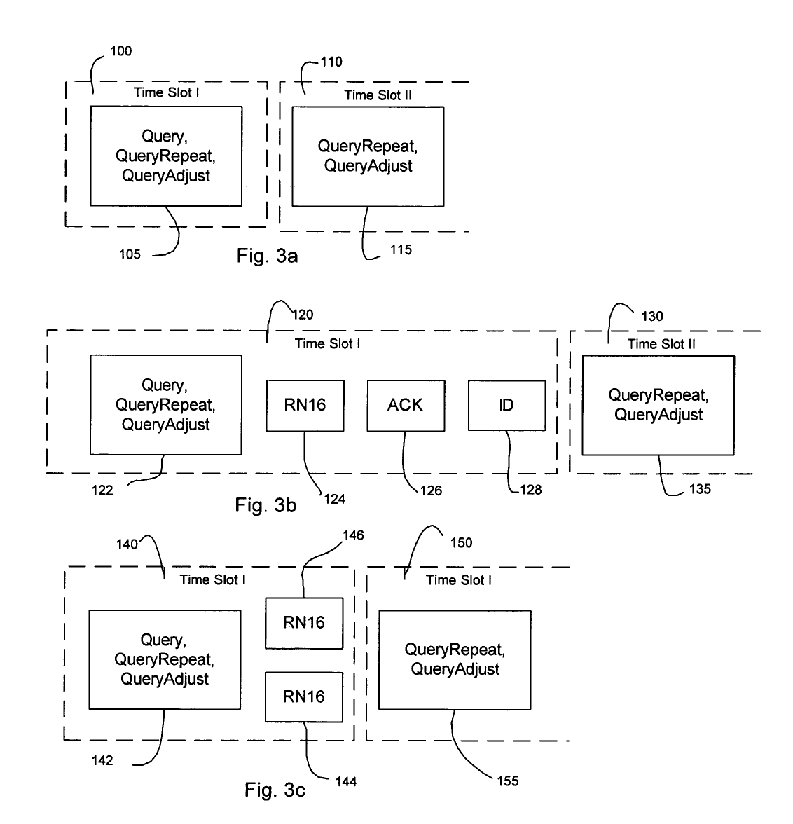

After each command signal is transmitted by the interrogator 4, any tag whose slot counter is zero transitions to a ‘reply’ state and transmits via backscatter a response signal (e.g., a 16-bit random number (RN16)). If none of the tags 6-10 respond in the slot after the command signal is transmitted (remain in an ‘arbitrate’ state), the slot is considered an “empty slot,” as shown in FIG. 3a. That is, the Time Slot I 100 begins when the command signal 105 is transmitted and ends when no reply is received from any of the tags, thereby indicating an empty slot. Thereafter, a new command signal 115 is transmitted indicating the beginning of a new Time Slot II 110. The Time Slot II 110 is shown as open-ended because it may also be an empty slot, a single-tag slot or a collided slot as will be described in greater detail below.

If a single tag (e.g., the tag 6) responds in the slot after the command is transmitted, the slot is considered a “single-tag slot,” as shown in FIG. 3b. In this case, Time Slot I 120 begins when the command signal 122 is transmitted and includes the RN16 124 received by the interrogator 4, and the subsequent acknowledgement (ACK) signal 126 to the tag 6. The ACK signal 126 repeats the RN16 124 from the response signal. If the tag 6 receives the ACK signal 126 with the RN16 124 from the response signal, the tag 6 transitions to an ‘acknowledgement’ state and transmits (e.g., via backscattering) an identification signal 128 including an identifier(s) (e.g., product code (PC), electronic product code (EPC) and/or cyclic redundancy check (CRC)). The tag 6 is then removed from the remainder of the inventory round by changing its inventory flag to a different state indicating that the tag 6 should be removed from the remainder of the inventory round (e.g., if session S1 state A is indicated in the inventory round, the S1 flag may be changed to state B indicating the tag is no longer in the current inventory round). The process of the tag 6 transmitting its identifier to the interrogator 4 is referred to as “singulation.” The Time Slot 1120 is then complete and a new Time Slot II 130 begins with the transmission of a new command 135.

If more than one tag (e.g., tags 6 and 8) transmits a response signal in the same slot, the slot is considered a “collided slot,” as shown in FIG. 3c. In this case, the Time Slot 1140 begins with the command 142 and includes the RN16 signal 144 and the RN16 signal 146. The interrogator 4 may attempt to resolve a single RN16 from the multiple response signals 144 and 146. If the RN16 from the tag 6 is resolved, the interrogator 4 transmits the ACK signal (not shown) to the tag 6. The tag 6 responds with the identification signal (not shown), while the tag 8 ignores the ACK signal and returns to an ‘arbitrate’ state, i.e., waiting to be singulated. If the tag 6 RN16 144 signal is resolved, the ACK signal and identification signal may also be part of the Time Slot 1140. However, it may be that neither RN16 signal 144 and 146 may be resolved and the Time Slot 1140 is complete as shown in FIG. 3c. The Time Slot II 150 then begins with the transmitting of the command 155. It should be noted that the above description shows that the slot duration may not be constant for each type of slot, but may depend on the type and number of responses that are made based on the command that starts each time slot.

From the above-description of an exemplary inventory round, those skilled in the art will understand that a choice of the parameter Q and the command signals transmitted by the interrogator 4 determine the statistic of the duration of the inventory round. According to the exemplary embodiments of the present invention, the interrogator 4 selects and transmits the command signals based on a probability that the transmitted command signal will yield a slot in which only one tag responds. In this manner, the interrogator 4 can reduce the average duration of the inventory round which, in turn, provides faster access to the data on the tags 6-10.

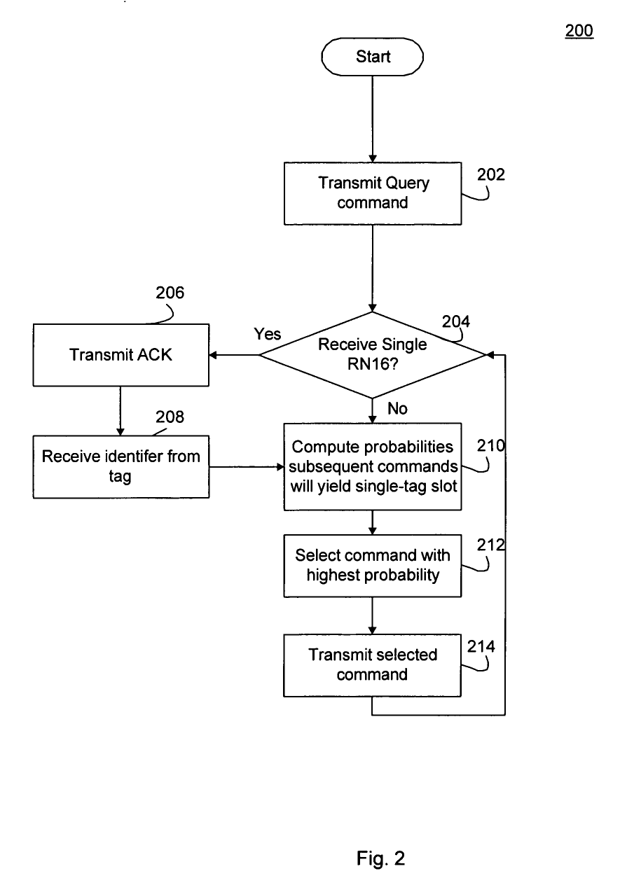

FIG. 2 shows an exemplary embodiment of a method 200 for identifying RFID tags according to the present invention. In the exemplary embodiment, the interrogator 4 (or a processor-based computing device coupled thereto) determines a command to transmit by evaluating which command will yield a maximum probability of getting a single-tag slot on an immediately subsequent slot. The commands that the interrogator 4 selects from include at least one of: QueryAdjust—decrement Q. QueryAdjust—maintain Q, QueryAdjust—increment Q and QueryRepeat.

In step 202, the interrogator 4 transmits a Query command signal to initiate an inventory round for the tags 6-10. As described above, the transmission of the Query command also starts the first time slot in the first frame. As stated above, the Query command signal includes the parameter Q which is used to determine a number of slots N in the inventory round, where N=2^{Q}. The tags 6-10 each select a slot in the number of slots N by choosing a random number between 0 and N−1. The random number is input into a slot counter and is adjusted based on subsequent commands from the interrogator 4 as the inventory round progresses. When the selected slot is reached (i.e., the slot counter reaches zero), the tag switches to a ‘reply’ state and transmits its RN16 to the interrogator 4.

In step 204, the interrogator 4 determines whether an RN16 has been received from one of the tags, i.e., whether the slot following the Query command signal was a single-tag slot. That is, one of the tags 6-10 may have chosen zero as the random number to input to their respective slot counters. If a single tag responds in step 204, the interrogator 4 transmits an ACK signal to the tag, as shown in step 206. Upon receipt of the ACK signal, the tag transitions to the ‘acknowledged’ state and transmits its identifier (e.g., PC, EPC and CRC-16) which is received by the interrogator 4, as shown in step 208.

If in step 204, it is determined that an RN16 signal is not received from a single tag (e.g., an empty slot or a collided slot), the first time slot is complete and the method continues to step 210 to determine which subsequent command should be sent to start the next time slot. As will be described in greater detail below, the determination is based on the probability that the subsequent command will result in the next time slot being a single-tag slot. In the alternative, if in step 204 it was determined that a single tag responded, the method, as described above, will proceed through steps 206 and 208. At the completion of step 208, the first time slot will be complete and the method also continues to step 210 to determine which subsequent command should be sent to start the next time slot. Thus, whether a single RN16 response is received or not in step 204, the method will eventually continue to step 210 to determine the next command to be transmitted. While the exemplary embodiment is described with reference to determining probabilities for a single-tag slot, those of skill in the art will understand that the probabilities for determining an empty slot and/or a collided slot may additionally or alternatively be computed. In the exemplary embodiment, the interrogator 4 computes a probability for at least one of a QueryAdjust—increment Q command, a QueryAdjust—maintain Q command, a QueryAdjust—decrement Q command and a QueryRepeat command.

If the interrogator 4 transmits a QueryAdjust command signal, the tags utilize a new parameter Q therein to generate a new number of slots in the new frame of the inventory round and then select a new random number to input into the slot counter. To compute the probability that the next slot will be a single-tag slot it is assumed that there are a total number of tags M in the selected tag population and that T tags have been read so far in the inventory round. The remaining unread tags (M−T) have selected one of the remaining slots N in the inventory round with a probability of 1/N. The N will be set as a function of the new parameter Q in the QueryAdjust command, i.e., N=2^{Q}. Thus, the probability that exactly m tags choose a particular slot is:

$$( \begin{matrix}M - T \\ m\end{matrix} ) {( \frac{1}{N} )}^{m} {( 1 - \frac{1}{N} )}^{M - T - m}$$

In the exemplary embodiment, m=1 because the probability of a single tag in the following slot after the QueryAdjust command is sought. Thus, the probability becomes:

$$( \begin{matrix}M - T \\ 1\end{matrix} ) {( \frac{1}{N} )}^{1} {( 1 - \frac{1}{N} )}^{M - T - 1} = \frac{M - T}{N} {( 1 - \frac{1}{N} )}^{M - T - 1}$$

### However, those of skill in the art will understand that for m>1, a probability of a collided slot may be determined.

Using the above formula when m=1, the probabilities for getting a single-tag slot to occur in the slot immediately following the QueryAdjust command signal can be determined for any of the QueryAdjust commands. In the following formulas, N_{current} is the number of slots N in the frame before the QueryAdjust command signal is transmitted. Thus, when the new parameter Q decrements (i.e., is less than) a former parameter Q, a new number of slots is equivalent to N_{current}/2, and when the new parameter Q increments (i.e., is greater than) a former parameter Q, the new number of slots is 2N_{current}. Thus, the probabilities may be determined as followed:

$$QueryAdjust \text{-} decrement Q prob \{ next slot is single \} = \frac{M - T}{{N}_{current} / 2} {( 1 - \frac{1}{{N}_{current} / 2} )}^{M - T - 1}$$

$$QueryAdjust \text{-} maintain Q prob \{ next slot is single \} = \frac{M - T}{{N}_{current}} {( 1 - \frac{1}{{N}_{current}} )}^{M - T - 1}$$

$$QueryAdjust \text{-} increment Q prob \{ next slot is single \} = \frac{M - T}{2 {N}_{current}} {( 1 - \frac{1}{2 {N}_{current}} )}^{M - T - 1}$$

The interrogator 4 may utilize the above formulas to determine which of the QueryAdjust commands is most likely to yield a single-tag slot immediately following the QueryAdjust command signal.

As explained above, a QueryRepeat command does not adjust the parameter Q but steps through the slots in the current frame one at a time by decrementing the value in the slot counters of the tags 6-10 to identify all of the tags 6-10 individually. As stated above, if a tag chooses a zeroth slot (n=0) (i.e., random number is 1), the tag responds in a slot immediately subsequent to the QueryAdjust or Query commands. Additionally, n slots are observed before the n^{th} QueryRepeat command. A random variable indicating whether the slot after the n^{th} QueryRepeat is a single tag slot or not is indicated as sₙ. Thus,

$${s}_{n} = \{ \begin{matrix}1 & slot after n QueryRep is a single \text{-} tag slot \\ 0 & slot after n QueryRep is an empty or collided slot\end{matrix}$$

Therefore, p(sₙ=1) is the probability that the slot after the n^{th} QueryRepeat command will be a single-tag slot. However, this probability may also take into account that e empty tag slots, s single-tag slots and c collided slots have been observed in the n observed slots (i.e., n=e+s+c). Also, as stated above, the tags 6-10 choose slots from the number of slot N in the current frame, and there are M tags participating in the inventory round which have not replied after a last QueryAdjust command signal has been transmitted. By total probability:

$$p ( {s}_{n} = 1 \vert e , s , c ; n , N , M ) = {\sum }_{r = 0}^{M} p ( {s}_{n} = 1 \vert r , e , s , c ; n , N , M ) p ( r \vert e , s , c ; n , N , M )$$

where r is the number of tags that are remaining to respond in this frame.

### However,

P(sₙ=1|r,e,s,c;n,N,M)=p(sₙ=1|r;n,N,M)

### Therefore,

$$p ( {s}_{n} = 1 \vert e , s , c ; n , N , M ) = {\sum }_{r = 0}^{M} p ( {s}_{n} = 1 \vert r ; n , N , M ) p ( r \vert e , s , c ; n , N , M )$$

Thus, p(sₙ=1|r;n,N,M) is the probability of getting a single tag slot given that r tags remain before the n^{th} QueryRepeat command, and p(r|e,s,c;n,N,M) is the probability of having r tags remaining tags after observing e empty tag slots, s single-tag slots and c collided tag slots in the n observed slots.

By Bayes' rule:

$$p ( r \vert e , s , c ; n , N , M ) = \frac{p ( e , s , c \vert r ; n , N , M ) p ( r ; n , N , M )}{p ( e , s , c ; n , N , M )}$$

The p(r;n,N,M) is the probability of having r tags remaining tags to be singulated after the n observed slots with N available slots and M tags still to be singulated after the last QueryAdjust command signal has been transmitted. This probability can be determined as:

$$p ( r ; n , N , M ) = ( \begin{matrix}M \\ r\end{matrix} ) {( \frac{n}{N} )}^{M - r} {( 1 - \frac{n}{N} )}^{r}$$

The p(e,s,c;n,N,M) is the probability that M tags will distribute themselves in N slots such that the first n observed slots will have e empty slots, s single-tag slots and c collided slots. As understood by those of skill in the art, there are N^{M} ways for M tags to distribute themselves in N slots. The probability of observing the e empty slots, s single-tag slots and c collided slots may be computed by counting combinations in which these observations may occur. The number of ways to have s single-tag slots in the n observed slots is:

$$( \begin{matrix}n \\ s\end{matrix} )$$

The number of ways to have c collided slots in the remaining n-s slots is:

$$( \begin{matrix}n - s \\ c\end{matrix} )$$

The number of ways to have e empty slots in the remaining n-s-c slots is:

$$( \begin{matrix}n - s - c \\ e\end{matrix} ) = 1$$

Thus, the n observed slots have been divided into three groups of sizes e, s and c. Applying a multinomial coefficient to the above groups, it is determined that:

$$( \begin{matrix}n \\ s\end{matrix} ) \cdot ( \begin{matrix}n - s \\ c\end{matrix} ) \cdot ( \begin{matrix}n - s - c \\ e\end{matrix} ) = \frac{n !}{e ! s ! c !}$$

The number of ways M tags can be placed in the s single tag slots one at a time can be computed by, for example:

$$\frac{M !}{( M - s ) !}$$

The number of ways the remaining M-s tags can be placed into the c collided slots (at least two at a time) and the N-n unobserved slots is computed by, for example, a recursion such as:

$$f ( c , T ) = {\sum }_{t = 2}^{T - 2 ( c - 1 )} ( \begin{matrix}T \\ t\end{matrix} ) f ( c - 1 , T - t )$$

$$f ( 0 , T ) = {( N - n )}^{T}$$

### In this case, c is a number of observed collided slots and T is a number of tags to distribute into the c observed collided slots and the N-n unobserved slots.

Thus, a joint probability density function may be:

$$p ( e , s , c ; n , N , M ) = \frac{\frac{n !}{e ! s ! c !} \cdot \frac{M !}{( M - s ) !} \cdot f ( c , M - s )}{{N}^{M}}$$

where the function f is defined above.

The probability p(e,s,c|r;n,N,M) is a distribution of the n observed slots that yields the e empty slots, s single-tag slots and c collided slots given r remaining tags after the n observed slots and with N available slots and M tags not yet singulated. This probability is similar to the probability that the distribution of the slots will be e empty, s single-tag, and c collided slots with n available slots and M-r tags participating, which is defined as:

$$\begin{matrix}p ( e , s , c \vert r ; n , N , M ) = \\ p ( e , s , c ; n , n , M - r ) = \frac{\frac{n !}{e ! s ! c !} \cdot \frac{( M - r ) !}{( M - r - s ) !} \cdot f ( c , M - r - s )}{{n}^{M - r}}\end{matrix}$$

Combining the probabilities for p(sₙ=1|r;n,N,M), p(r;n,N,M), p(r|e,s,c;n,N,M) and p(e,s,c;n,n,M−r) yields the probability of getting a single-tag slot after issuing a QueryRepeat command and taking into consideration the observed slot types (e empty slots, s single-tag slots, c collided slots) since the last QueryAdjust command signal was transmitted.

In step 212, the interrogator 4 selects a command signal to transmit based on the determined probabilities and transmits the selected command signal (step 214). The transmission of the selected command begins the new time slot and the method continues back to step 204 to determine if the selected command results in a single-tag slot. As understood by those skilled in the art, the interrogator 4 may continue the above-described process until all of the tags in the selected population have been identified. After the Inventory process is complete, the interrogator 4 may interface with one or more of the tags using the Access process, as defined in the Gen2 specification.

Those skilled in the art will understand that the exemplary embodiments of the present invention provide an optimization for the Q algorithm utilized in the Inventory process in an RFID system. By identifying probabilities of getting a single-tag slot on a slot subsequent to a command signal, a duration of the inventory round may be optimally minimized.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
transmitting a command signal in a time slot to a plurality of wireless communication devices, the command signal indicating initiation of an identification process for identifying each of the wireless devices, the identification process including a plurality of time slots; and
computing a probability that a subsequent command signal transmitted in a subsequent time slot will cause only one of the wireless devices to transmit a response signal in the subsequent time slot.

2. The method according to claim 1, wherein the command signal is a Query command.

3. The method according to claim 1, wherein the wireless devices are radio frequency identification (RFID) tags.

4. The method according to claim 1, wherein the subsequent command signal is one of a QueryAdjust command and a QueryRepeat command.

5. The method according to claim 4, wherein the QueryAdjust command is one of (i) a QueryAdjust—decrement Q command, (ii) a QueryAdjust—increment Q command and (iii) a QueryAdjust—maintain Q command.

6. The method according to claim 5, further comprising:
computing the probability for each of (i) the QueryAdjust—decrement Q command, (ii) the QueryAdjust—increment Q command and (iii) the QueryAdjust—maintain Q command and (iv) the QueryRepeat command.

7. The method according to claim 6, further comprising:
selecting one of (i), (ii), (iii) and (iv) based on a highest probability.

8. The method according to claim 5, further comprising:
computing the probability for (i) using:
$$= \frac{M - T}{{N}_{current} / 2} {( 1 - \frac{1}{{N}_{current} / 2} )}^{M - T - 1}$$
where
M is a total number of wireless devices
N_{current} is a total number of time slots in the identification process immediately prior to transmission of the subsequent command signal; and
T is a total number of wireless devices which already transmitted their respective data.

9. The method according to claim 5, further comprising:
computing the probability for (ii) using:
$$= \frac{M - T}{2 {N}_{current}} {( 1 - \frac{1}{2 {N}_{current}} )}^{M - T - 1}$$
where
M is a total number of wireless devices
N_{current} is a total number of time slots in the identification process immediately prior to transmission of the subsequent command signal; and
T is a total number of wireless devices which already transmitted their respective data.

10. The method according to claim 5, further comprising:
computing the probability for (iii) using:
$$= \frac{M - T}{{N}_{current}} {( 1 - \frac{1}{{N}_{current}} )}^{M - T - 1}$$
where
M is a total number of wireless devices
N_{current} is a total number of time slots in the identification process immediately prior to transmission of the subsequent command signal; and
T is a total number of wireless devices which already transmitted their respective data.

11. The method according to claim 4, further comprising:
computing the probability for the QueryRepeat command using
$$p ( {s}_{n} = 1 \vert e , s , c ; n , N , M ) = {\sum }_{r = 0}^{M} p ( {s}_{n} = 1 \vert r ; n , N , M ) p ( r \vert e , s , c ; n , N , M )$$
where
p(sₙ=1|r;n,N,M) is a probability that a single wireless device will transmit a response single in the subsequent time slot given that:
r wireless devices remain before an n^{th} QueryRepeat command is transmitted;
N is a total number of time slots in a current frame; and
M is a number of the wireless devices which have not yet transmitted their respective data, and
p(r|e,s,c;n,N,M) is a probability of having the r wireless devices after observing e empty tag slots, s single-tag slots and c collided tag slots in n observed time slots of the N total number of time slots.

12. The method according to claim 1, further comprising:
transmitting the subsequent command signal in the subsequent time slot to the wireless devices.

13. A device, comprising:
a wireless communication arrangement transmitting a command signal in a time slot to a plurality of wireless communication devices, the command signal indicating initiation of an identification process for identifying each of the wireless devices, the identification process including a plurality of time slots; and
a processor computing a probability that a subsequent command signal transmitted in a subsequent time slot will cause only one of the wireless devices to transmit a response signal in the subsequent time slot.

14. The device according to claim 13, wherein the wireless communication arrangement is an RFID interrogator.

15. The device according to claim 13, wherein the wireless devices are radio frequency identification (RFID) tags.

16. The device according to claim 13, wherein the subsequent command signal is one of (i) a QueryAdjust—decrement Q command, (ii) a QueryAdjust—increment Q command, (iii) a QueryAdjust—maintain Q command and (iv) a QueryRepeat command.

17. The device according to claim 16, wherein the processor computes the probability for each of (i) the QueryAdjust—decrement Q command, (ii) the QueryAdjust—increment Q command and (iii) the QueryAdjust—maintain Q command and (iv) the QueryRepeat command.

18. The device according to claim 17, wherein the processor selects one of (i), (ii), (iii) and (iv) based on a highest probability and transmits the selected one via the wireless communication arrangement.

19. A system, comprising:
a plurality of first wireless communication devices; and
a second wireless communication device transmitting a command signal in a time slot to the first devices, the command signal indicating initiation of an identification process for identifying each of the first devices, the identification process including a plurality of time slots, the second device computing a probability that a subsequent command signal transmitted in a subsequent time slot will cause only one of the first devices to transmit a response signal in the subsequent time slot.

20. The system according to claim 19, wherein the first devices are RFID tags and the second device is an RFID interrogator.

21. A device, comprising:
a radio frequency communication means for transmitting a command signal in a time slot to a plurality of wireless communication devices, the command signal indicating initiation of an identification process for identifying each of the wireless devices, the identification process including a plurality of time slots; and
a processing means for computing a probability that a subsequent command signal transmitted in a subsequent time slot will cause only one of the wireless devices to transmit a response signal in the subsequent time slot.
